(19) United States
(12) Patent Application Publication
(10) Pub. No.: US 2008/0078711 A1
(43) Pub. Date: Apr. 3, 2008

(54) POOL SWEEP FILTER ADAPTER

(76) Inventor: LEWIS ENSOR, Tustin, CA (US)

Correspondence Address: LEWIS C. ENSOR, 14841 BRAEBURN RD., TUSTIN, CA, 92780, US

(21) Appl. No.: 11/537,297

(22) Filed: Sep. 29, 2006

(51) Int. Cl. B01D 35/28

(52) U.S. Cl. 210/167.1; 210/167.16; 210/167.17; 210/452; 210/337; 210/483

(57) ABSTRACT

A Pool Sweep Filter Adapter provides connection between the inlet to a swimming pool leaf catcher basket and the pool vacuum hose, said hose is also attached to a pool vacuum head with an attached long tubular handle to move the head around the pool surfaces manually, or said hose is connected to an existing automatic pool sweep mechanism, for collection of leaves, hair and dirt into an existing said leaf catcher basket; in contrast to present methods that require the removal of the leaf catcher basket during vacuum cleaning of the pool that allows the leaves and debris to go directly to the pool pump and then to the pool main filter, said Pool Sweep Filter Adapter includes an option for a fine mesh filter bag to collect smaller leaf particles and dirt.

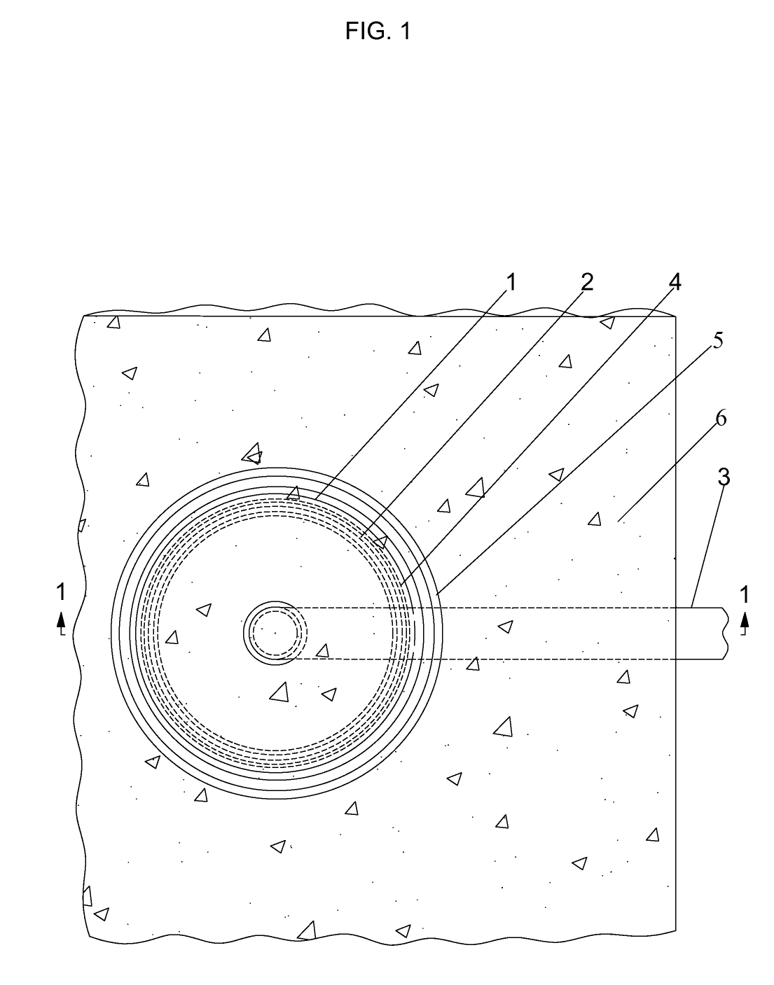

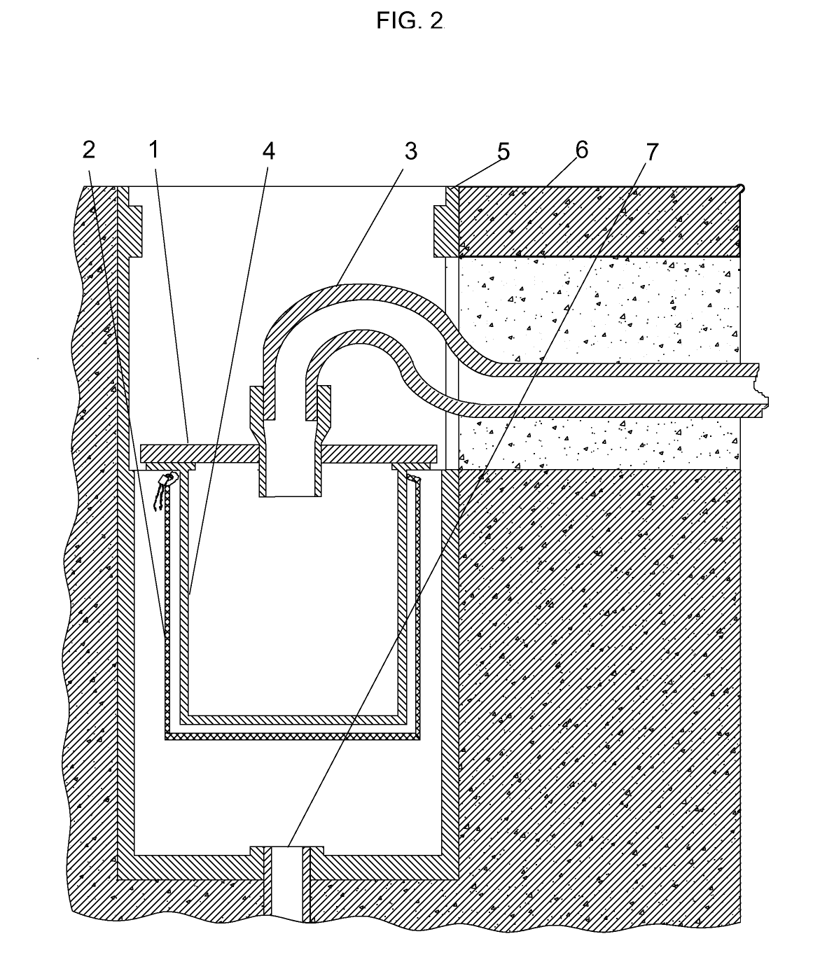

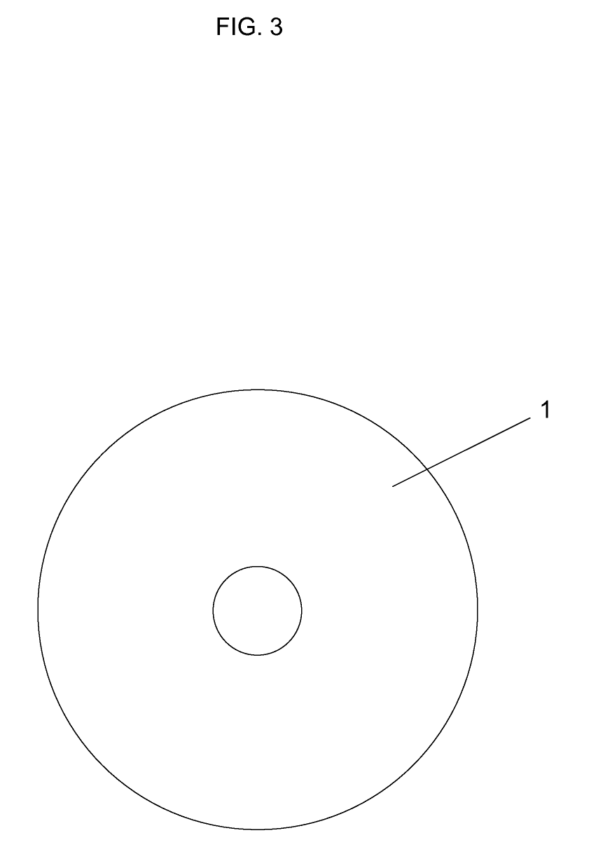

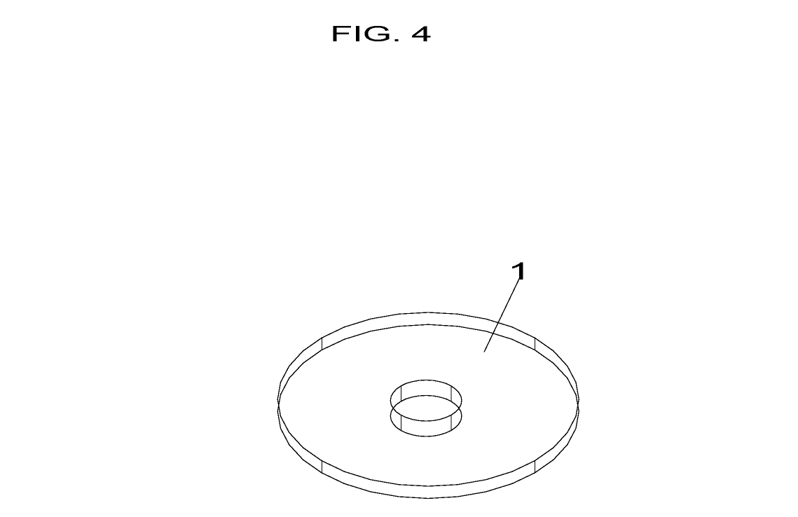

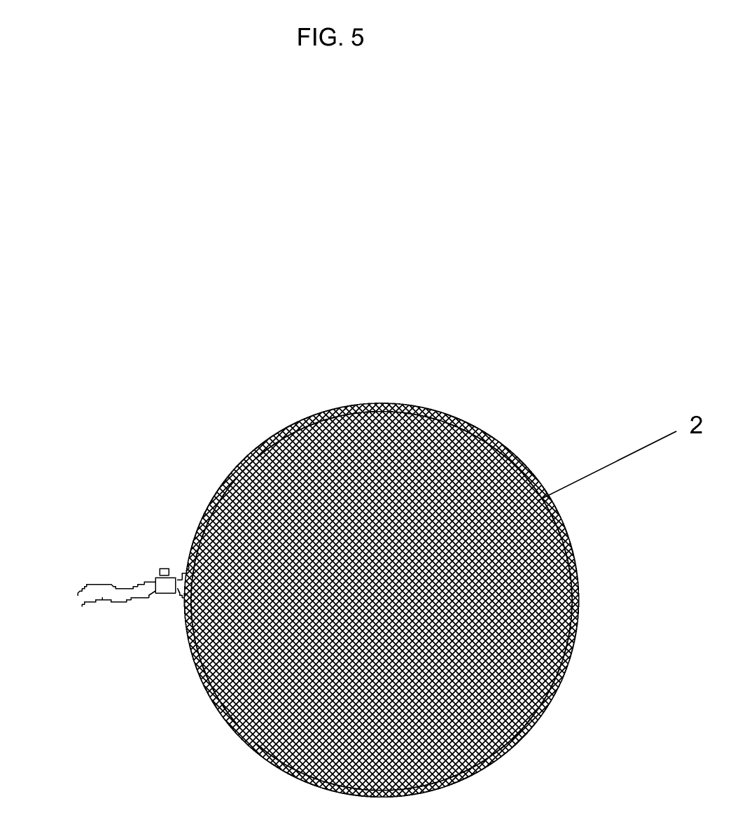

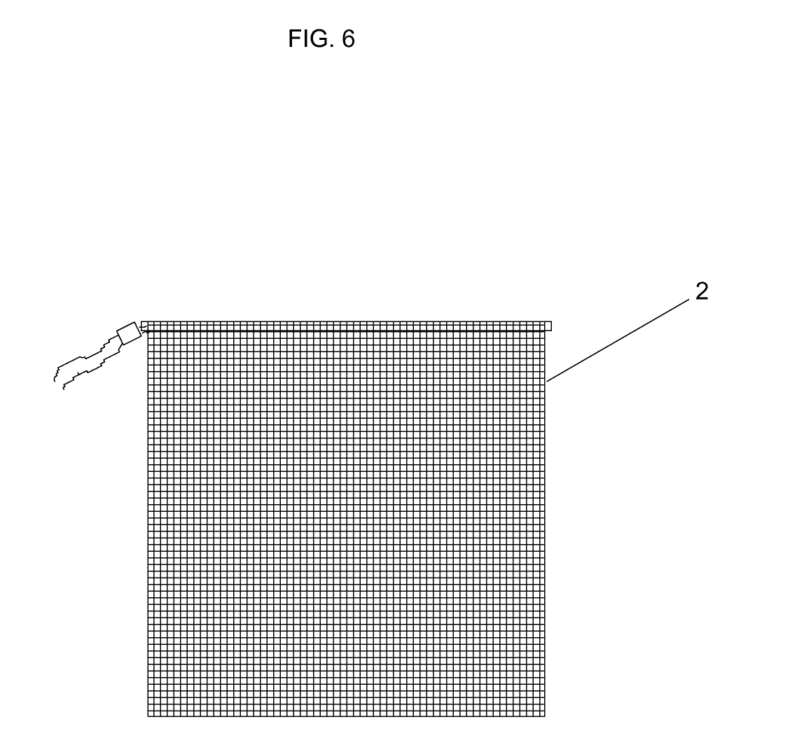

Pool Sweep Filter Adapter plate of rigid plastic, metal, wood or other impervious material, that withstands water exposure, is held in position covering the top inlet of the existing swimming pool leaf catcher basket by the vacuum created by the existing pool pump, said Adapter has an opening of a diameter to allow an existing pool vacuum hose to mate and to be sealed thereto, providing vacuum through the hose connected to the manual or automatic pool sweep head, for the leaves, hair and dirt to be pulled into the sweep head and through the hose and Pool Sweep Filter Adapter to the top opening of said leaf catcher basket where the larger leaves and materials are held inside of said basket by the existing mesh walls.

The filtered water flows through mesh walls of said basket to an optional filter bag of porous cloth, fiberglass, and or plastic, said filter bag is held in place with a draw string around the basket as a Pool Sweep Filter Adapter Fine Filter to remove this smaller material to be disposed of, along with those materials in the leaf catcher, after the pool vacuum cleaning is completed.

### BACKGROUND OF THE INVENTION

1. Field of the Invention

A Pool Sweep Filter Adapter provides connection between the inlet of a swimming pool leaf catcher basket and the pool vacuum hose connected to the vacuum head of a pool sweep mechanism, either manual or automatic. Thus the pool leaf catcher basket stays in place during vacuum sweeping to collect debris.

2. Description of Prior Art

Typically a swimming pool includes a housing, generally indicated as 5, recessed into the pool deck, generally indicated as 6. said housing has an opening near the top but below the pool water level, and with a similar size opening in a wall in a side of the pool allowing water to flow from the pool and into the housing. A leaf catcher basket that is a cylindrical container with a top opening for water inlet and with small holes forming a mesh strainer its the bottom and in its sides is suspended on a circular shelf in said housing below the pool water level; collecting leaves, hair and dirt that is of larger size than the mesh openings in the basket as the water is pumped from the pool.

When the pool has leaves and dirt enough to require cleaning, a vacuum hose is connected to the pool pump inlet pipe, generally indicated as 7, located at the bottom of said housing to provide vacuum for vacuum sweeping of the pool surfaces. However present procedure requires that said leaf catcher basket be removed for access to the said inlet pipe for said hose connection that is used for manual or automatic sweep mechanisms, and thus all of the leaves, hair and dirt go directly to the pump and then to the main pool filter. The result, with the basket removed during vacuum sweep of the pool, is that the pump can become clogged and less efficient, and then the pool water is not filtered properly resulting in inadequate chlorination and the growth of algae. The water flow can be reduced so small that the pump requires cleaning and the motor can overheat and may be damaged. The main large pool filter requires cleaning and or back flushing more often that resulted in damage potential to the filter disks and more cost for the more frequent replacement of the diatomaceous earth for each cleaning.

The Pool Sweep Filter Adapter provides connection of the vacuum hose at the top inlet of the leaf catcher basket while said basket is in place in the existing said housing allowing leaves, hair and dirt to be collected therein during the vacuum operation.

What is claimed is:

1. A Pool Sweep Filter Adapter plate of rigid plastic, metal, wood or other impervious material, that withstands water exposure, is held in position covering the top inlet of the existing swimming pool leaf catcher basket by the vacuum created by the existing pool pump, said Adapter has an opening of a diameter to allow an existing pool vacuum hose to mate and to be sealed thereto, providing vacuum through the hose to the manual or automatic pool sweep head, for the leaves, hair and dirt to be pulled into the sweep head and through the hose and Pool Sweep Filter Adapter to said leaf catcher basket where the larger leaves and materials are held inside of said basket by the existing mesh walls.

2. The filtered water flows through mesh walls of said basket to an optional filter bag of porous cloth, fiberglass, plastic and or other porous material that withstands water exposure, and held in place around the basket as a Pool Sweep Filter Adapter Fine Filter to remove this smaller material to be disposed of, along with those materials in the leaf catcher, after the pool vacuum cleaning is completed.
